(19) United States
(12) Patent Application Publication
(10) Pub. No.: US 2025/0324464 A1
(43) Pub. Date: Oct. 16, 2025

(54) MECHANISMS AND PROCEDURES FOR LOW LATENCY TRAFFIC TRANSMISSION IN WLAN SYSTEMS

(71) Applicant: INTERDIGITAL PATENT HOLDINGS, INC., Wilmington, DE (US)

(72) Inventors: Hanqing LOU, Syosset, NY (US); Xiaofei WANG, North Caldwell, NJ (US); Ying WANG, Easton, PA (US); Rui YANG, Greenlawn, NY (US)

(21) Appl. No.: 18/632,118

(22) Filed: Apr. 10, 2024

(51) Int. Cl. H04W 74/0833; H04W 74/08; H04W 84/12

(52) U.S. Cl. CPC H04W 74/085; H04W 74/0875; H04W 84/12

(57) ABSTRACT

Methods and apparatuses are disclosed for a station (STA) in a Wireless Local Area Network (WLAN) to indicate its intent to transmit high priority traffic, such as low latency traffic, over a shared wireless medium. Multiple embodiments for the transmission by a STA of a signal referred to as a Low Latency Traffic Indication (LLTI) as well as low latency traffic are disclosed. An Access Point (AP) manages the conditions subject to which STAs may transmit the LLTI and contend for the wireless medium for the purpose of transmitting low latency traffic, and may solicit the LLTI and low latency traffic from the STAs. Multiple embodiments of methods and apparatuses are disclosed.

### CROSS-REFERENCE TO RELATED APPLICATIONS

This application is being filed on even date herewith with U.S. patent application Ser. No. ____, filed under Attorney Docket No. 2024P00230 US, and incorporated herein by reference in its entirety.

### BACKGROUND

A wireless local area network (WLAN) in Infrastructure Basic Service Set (BSS) mode has an Access Point (AP) for the BSS and one or more stations (STAs) associated with the AP. The AP typically has access or interfaces to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA. For certain kinds of traffic, referred to herein as “low latency traffic,” such as traffic for which it may be necessary or desirable to meet, for example, certain maximum delay and/or jitter requirements, it may be desirable to adopt latency management features in a WLAN.

### SUMMARY

One or more of the foregoing issues or needs may be addressed by aspects of the embodiments disclosed herein.

In certain aspects, embodiments of a method are disclosed for a station (STA), the method comprising: transmitting a frame with an indication of high priority traffic and associated transmission parameters over a wireless medium in a Wireless Local Area Network (WLAN); performing backoff before transmitting the high priority traffic; determining whether a transmission over the wireless medium has occurred during the backoff; transmitting the high priority traffic over the wireless medium if it is determined that a transmission over the wireless medium during the backoff has not occurred; and deferring transmitting the high priority traffic over the wireless medium if it is determined that a transmission over the wireless medium has occurred during the backoff.

In certain aspects, embodiments of a station (STA) are disclosed comprising a transceiver and a processor communicatively coupled to the transceiver, the transceiver and processor configured to: transmit a frame with an indication of high priority traffic and associated transmission parameters over a wireless medium in a Wireless Local Area Network (WLAN); perform backoff before transmitting the high priority traffic; determine whether a transmission over the wireless medium has occurred during the backoff; transmit the high priority traffic over the wireless medium if it is determined that a transmission over the wireless medium during the backoff has not occurred; and defer transmitting the high priority traffic over the wireless medium if it is determined that a transmission over the wireless medium has occurred during the backoff.

In certain aspects, embodiments of a method are disclosed for a station (STA), the method comprising: receiving a high priority traffic solicitation from an Access Point (AP) over a wireless medium in a Wireless Local Area Network (WLAN); and transmitting at least one of an indication of high priority traffic or high priority traffic over the wireless medium in accordance with the high priority traffic solicitation.

In certain aspects, embodiments of a station (STA) are disclosed comprising a transceiver and a processor communicatively coupled to the transceiver, the transceiver and processor configured to: receive a high priority traffic solicitation from an Access Point (AP) over a wireless medium in a Wireless Local Area Network (WLAN); and transmit at least one of an indication of high priority traffic or high priority traffic over the wireless medium in accordance with the high priority traffic solicitation.

In certain aspects, embodiments of a method are disclosed for an access point (AP), the method comprising: transmitting to a station (STA) over a wireless medium in a Wireless Local Area Network (WLAN) a high priority traffic solicitation; and receiving from the STA at least one of an indication of high priority traffic or high priority traffic over the wireless medium in accordance with the high priority traffic solicitation.

Additional aspects are also disclosed.

One or more embodiments also provide a computer program comprising instructions which when executed by one or more processors cause the one or more processors to perform the methods according to any of the embodiments described herein.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of an example wireless local area network (WLAN) in which one or more disclosed embodiments may be implemented;

FIG. 3 is a timing diagram illustrating representative operation with a TXOP duration set to ensure priority access for low latency traffic;

FIG. 4 shows an example format of a low latency traffic indication (LLTI) Null Data Packet (NDP) Physical Layer Protocol Data Unit (PPDU) used in a WLAN;

FIG. 5 is a timing diagram illustrating a representative procedure of AP solicitation of LLTI;

FIG. 6 is a timing diagram illustrating a representative procedure of AP solicitation of uplink OFDMA random access (UORA) LLTI; and

FIG. 7 is a timing diagram illustrating a representative procedure of AP solicitation of UORA low latency transmission.

### DETAILED DESCRIPTION

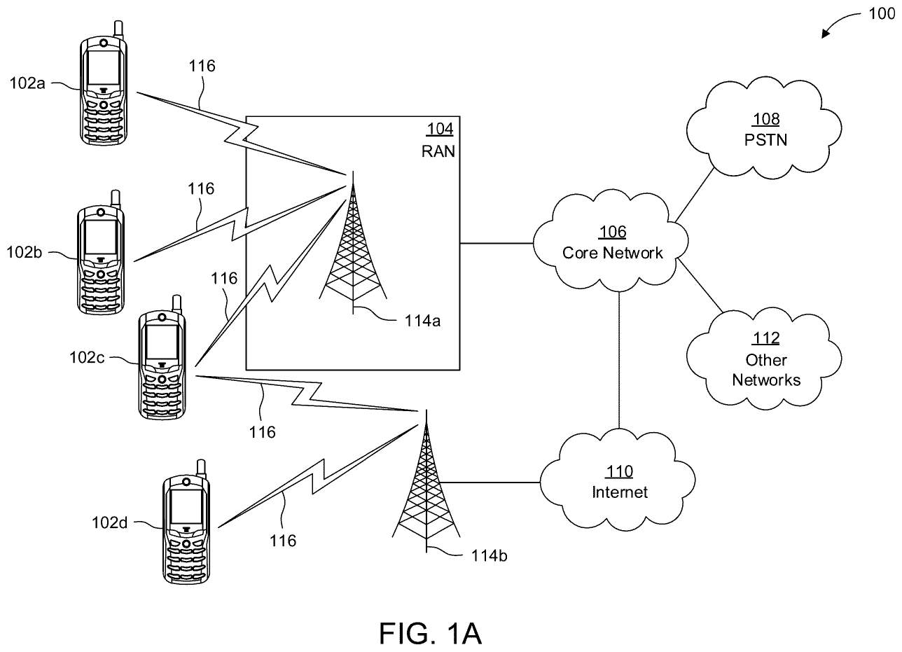

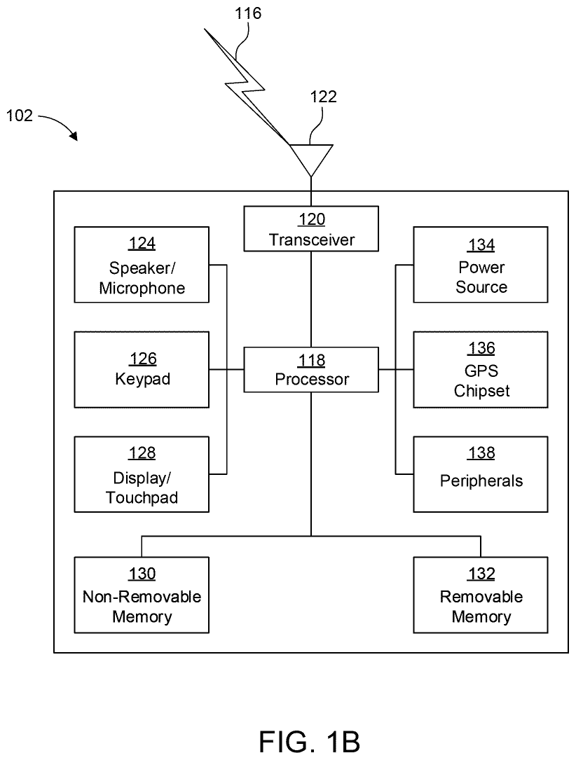

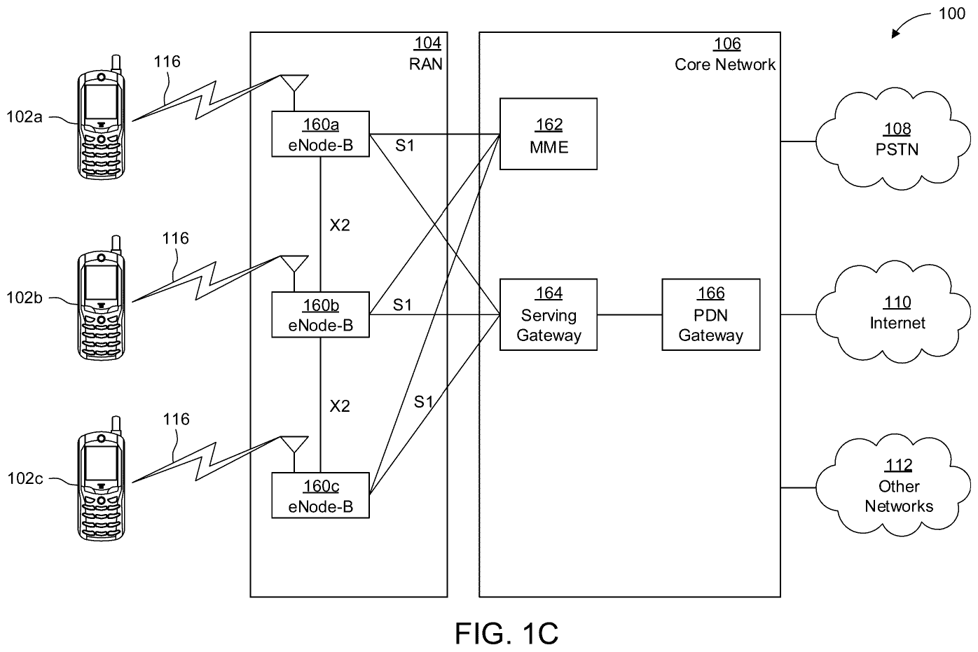

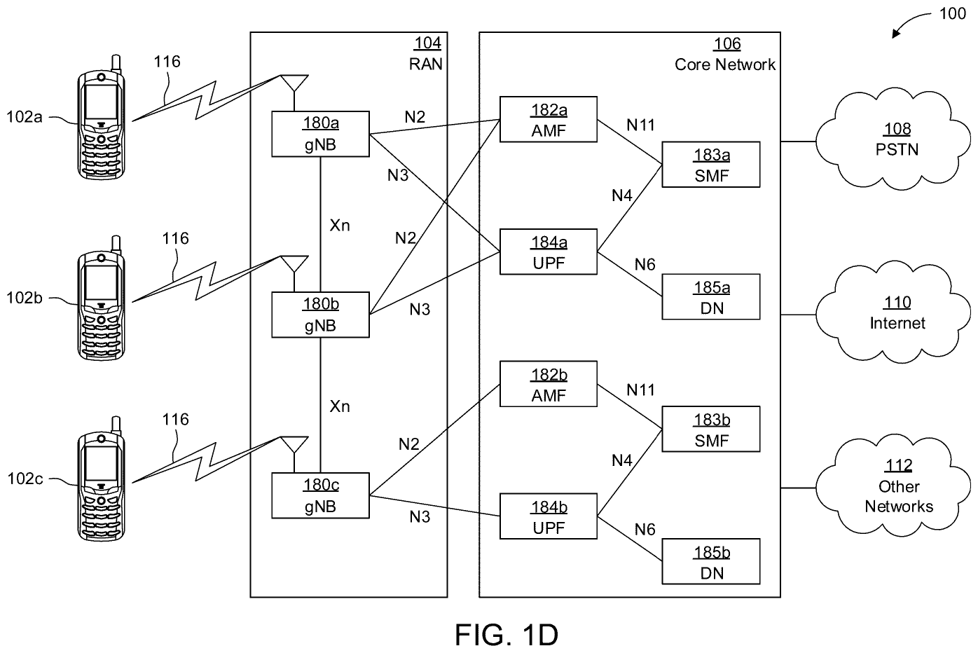

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

### Low Latency Traffic Channel Access

According to existing channel access procedures, IEEE 802.11 stations (STAs) usually perform a random backoff procedure before transmitting for each contention period.

When a STA with a frame queued for transmission determines that the wireless medium is idle and the wireless medium remains idle for a period of a Distributed Inter-Frame Space (DIFS) or an Extended Inter-Frame Space (EIFS) from the end of the immediately preceding medium-busy event, the STA may invoke a random backoff procedure. The STA may start transmitting if the wireless medium remains idle after a backoff counter at the STA that is set to a randomly chosen initial value decrements down to 0. The backoff counter is set to an integer value chosen randomly with a uniform distribution between 0 to CW[AC], where CW is an integer value between aCWmin and aCWmax, and AC is an index corresponding to an access category (e.g., voice, video, best effort, background). aCWmin and aCWmax are values set by the AP. The STA (AP or non-AP) will set the initial value of CW to aCWmin. CW is doubled when a collision or transmission failure occurs but is capped by aCWmax. CW is reset to aCWmin after every successful transmission. If no medium activity is indicated for the duration of a particular backoff slot, then the backoff procedure shall decrement its backoff counter.

To support low latency traffic transmission, one approach is to allow STAs with low latency traffic to transmit a Defer Signal (DS) without backoff in a contention period. After receiving a Defer Signal, STAs without low latency traffic may hold their contention and wait for the next transmission opportunity (TXOP). Meanwhile, the STAs that have just transmitted the Defer Signal (DS) may start a backoff procedure to contend for the channel access to transmit their low latency traffic. This backoff procedure reduces the chance of transmission collision among the STAs with low latency traffic. Also note that for such STAs, the contention window value CW may be smaller than those for legacy STAs or STAs without low latency traffic.

A purpose of the Defer Signal (DS), or the like, is to give STAs with low latency traffic a chance to access the medium in an aggressive way, in that the transmission of the DS is without any backoff. Any aggressive STA, however, regardless of the type of traffic (low latency or not) it may have, can always transmit the DS at the beginning of a contention period. If there is one such aggressive STA in a BSS, it will always be able to occupy the medium whenever it wants. If there is a group of such aggressive STAs in a BSS, this group of STAs will always have a higher priority to access the medium than the other STAs in the BSS. If all the STAs in a BSS are aggressive STAs, then the situation is like traditional channel access, except that the DS is always transmitted, unnecessarily, and becomes an additional overhead for any contention period. Therefore, to give STAs with low latency traffic high priority to access the medium by using a DS, or the like, while still maintaining a certain degree of fairness among other STAs in the network and preventing intentionally aggressive STAs from occupying the medium unnecessarily, a flexible control mechanism is desirable.

In a WLAN, it may be desirable that a STA with low latency traffic enjoy higher priority to access the wireless medium than a STA without low latency traffic. In representative embodiments in accordance with the present disclosure, a STA with low latency traffic can transmit such traffic with limited or no backoff by first transmitting a signal referred to herein as a Low Latency Traffic Indication (LLTI), LLTI signal, or LLTI frame.

More than one STA may transmit an LLTI signal concurrently. The LLTI signal may be transmitted without backoff. After the LLTI signal is transmitted, STAs which have low latency traffic and/or had transmitted the LLTI signal may be able to contend for the wireless medium. Limited backoff may entail using a backoff procedure with higher priority, and/or a lower backoff counter, etc. After transmission of the LLTI signal, a STA may perform a backoff procedure, in which it randomly determines a backoff period, senses the wireless medium for any transmission activity thereon, and if in that backoff period does not sense any such activity, may then proceed to transmit its low latency traffic on the wireless medium.

A STA without low latency traffic or which has not transmitted the LLTI signal may withhold transmission after detecting transmission of an LLTI signal from other STA(s). For example, after it detects an LLTI signal, a STA without low latency traffic may defer its channel access.

The aforementioned procedures may be allowed in a certain period of time or duration, such, as for example, within a TXOP, within a beacon interval, or for any contention period, which may be given dynamically or semi-statically.

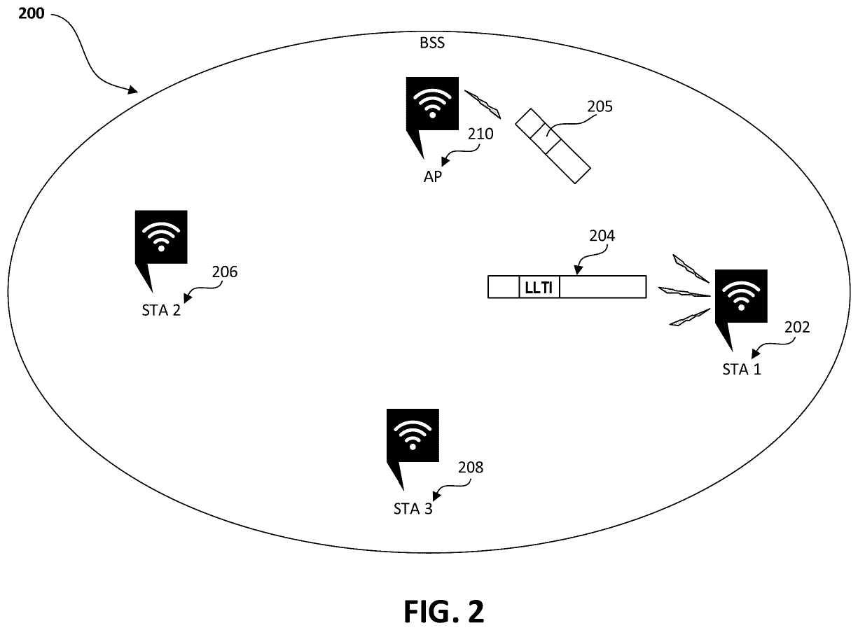

FIG. 2 shows an example WLAN 200 including a STA 202, a STA 206, a STA 208, and an AP 210. The WLAN 200 is in Infrastructure Basic Service Set (BSS) mode, with the STAs 202, 206, and 208 and the AP 210 considered to constitute a BSS. In the illustrative scenario depicted in FIG. 2, the STA 202 has transmitted a LLTI frame 204 to indicate its need to transmit low latency traffic and to inform non-low-latency transmitting STAs to defer transmission of their traffic. Transmission of the LLTI frame 204 is based on an LLTI management element 205 received from, for example, AP 210. LLTI management element 205 provides one or more conditions for managing the transmission of low latency traffic by facilitating and managing the transmission of the LLTI frame 204. Representative contents of the LLTI management element 205 are described in U.S. patent application Ser. No. ____, filed on even date herewith under Attorney Docket No. 2024P00230 US and incorporated herein by reference in its entirety.

### Transmission of the LLTI Signal

Multiple embodiments and variants thereof of methods for transmission of the LLTI signal will now be described.

### Method I

In representative embodiments in accordance with the present disclosure, transmission of an LLTI signal may be carried out in a way so that following a transmission of the LLTI signal, a legacy STA will use an Extended Inter-Frame Space (EIFS) before contending for or transmitting on the wireless medium. In such implementations, the LLTI may be carried by a Physical Layer Protocol Data Unit (PPDU), referred to herein as a UHR or UHR+PPDU, where “UHR+” represents any generation(s) of 802.11 standards after UHR/802.11bn.

A STA may use EIFS before transmission on the medium when it determines that the medium is idle following a PPDU for which the PHY_RXEND.indication primitive contained an error or a frame for which the frame check sequence (FCS) value was not correct. As such, one way to force a legacy STA to use EIFS is to have the STA issue a PHY_RXEND.indication primitive containing an error.

Whereas a legacy STA may be able to detect the L-SIG field of a UHR PPDU, it would not understand the other SIG fields of the UHR PPDU, such as the SIG fields for UHR or a UHR+ generation of WiFi signals. As such, for a UHR/UHR+PPDU carrying the LLTI, a legacy STA would issue a PHY_RXEND.indication primitive containing an error and/or the frame check sequence (FCS) value would be incorrect.

In representative embodiments, the LLTI signal may be transmitted on the primary 20 MHz channel. Legacy STAs in the same BSS may detect the transmission on the primary 20 MHz channel and withhold contention for the medium until an EIFS time afterwards. LLTI-aware STAs may detect the transmission on the primary 20 MHz channel and knowing it is an LLTI signal may thus refrain from performing any transmission on the primary and/or secondary channels for the duration of the TXOP of the LLTI.

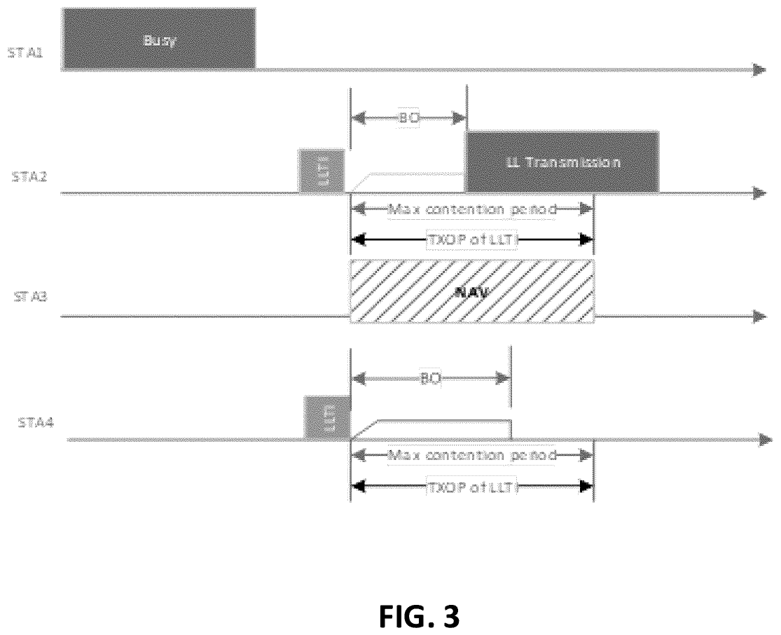

When the LLTI is carried by a UHR/UHR+PPDU, the signaling field of the UHR/UHR+PPDU (e.g., U-SIG, UHR-SIG, etc.) may be set in accordance with the following rules:
The BW field may be set to indicate the bandwidth of the UHR/UHR+PPDU which carries the LLTI. For example, the BW field may be set to 20 MHz.
The TXOP field may be set to a value that allows a STA which understands the TXOP field to set a Network Allocation Vector (NAV) long enough to cover the maximum possible contention period following transmission of the LLTI. FIG. 3 illustrates the setting of a TXOP duration to ensure priority access for low latency traffic. In this example, a Maximum Contention Period for LLTI may be predefined or determined and broadcasted by the AP. The Maximum Contention Period for LLTI may be the maximum backoff duration for STAs to access the wireless medium right after their LLTI transmission. The TXOP field in the U-SIG field may be set to a value which is equal to or approximately equal to, the Maximum Contention Period for LLTI. An unintended UHR/UHR+STA (i.e., a STA, such as STA3 in the example of FIG. 3, which did not transmit the LLTI for the current TXOP), may use the TXOP field to set its NAV. In this way, an unintended UHR STA may perform contention after a period indicated by its NAV setting. The STAs which transmitted the LLTI may perform backoff right after the LLTI. Since the backoff duration is smaller than the Maximum Contention Period and thus smaller than the NAV set by the unintended STA(s), one of the STAs that transmitted the LLTI will be guaranteed to acquire the channel. In the example scenario illustrated in FIG. 3, STA2 acquires the channel.
The BSS Color field may be set to indicate the BSS color of the BSS. As such, the PPDU which carries the LLTI may be different from one BSS to another. Alternatively, the BSS Color field may be set to an unassigned value so that STAs from different BSSs may have the same value.
The UL/DL field may be set to UL. In a case in which an AP transmits the LLTI concurrently with non-AP STA(s), the AP may need to set the UL/DL field to UL so that the overlapping LLTI PPDUs from the AP and the non-AP STA(s) may be the same, thereby making it possible for the STAs that receive the overlapping LLTI PPDUs to decode them. Alternatively, the UL/DL field may be set to DL, even if it is transmitted by a non-AP STA. The baseline is for all the current LLTI transmitters of the same BSS and/or of different BSSs to set this field to the same value so that the receiving STAs may be able to decode the PPDUs.

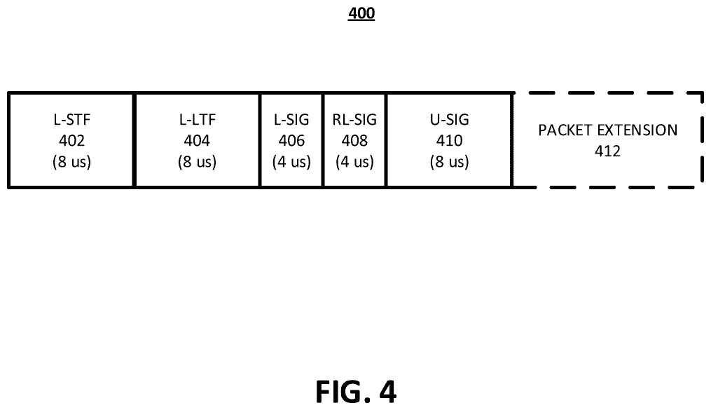

In representative embodiments, the LLTI may be carried by a UHR/UHR+ Null Data Packet (NDP) PPDU. An exemplary format of such an LLTI NDP 400 is shown in FIG. 4.

The LLTI NDP 400 may contain an L-STF field 402, an L-LTF field 404, an L-SIG field 406, an RL-SIG field 408, and a U-SIG field 410. A Packet Extension (PE) field 412 may be included at the end of the LLTI NDP.

In representative embodiments, the LLTI NDP 400 can be indicated implicitly by the Length field in the L-SIG field 406. The TXTIME for the LLTI NDP 400 may be set to cover all of the fields of the LLTI NDP 400. For example, if the example LLTI NDP 400 shown in FIG. 4 does not have a PE field 412, then TXTIME=8+8+4+4+8=32 and SignalExtension=0. Following the existing method,

$$Length = ⌈ \frac{TXTIME - SignalExtension - 20}{4} ⌉ \times 3 - 3 = 6 \qquad ( 1 )$$

In other words, for such an LLTI NDP 400, the Length field in its L-SIG field 406 would be set to 6. Additionally, the PHY Version Identifier field in its U-SIG field 410 would be set to indicate that the LLTI NDP 400 is a UHR/UHR+PPDU. As such, a STA receiving such a PPDU can determine that the PPDU is a UHR/UHR+ LLTI NDP, such as that shown in FIG. 4.

In representative embodiments, the TXTIME parameter is returned by the PLME-TXTIME.confirm primitive, as described in IEEE P802.11be™/D5.0 “Draft Standard for Information technology—Telecommunications and information exchange between systems Local and metropolitan area networks—Specific requirements, Part 11: Wireless LAN Medium Access Control (MAC) and Physical Layer (PHY) Specifications, Amendment 8: Enhancements for extremely high throughput (EHT),” November 2023, at 36.4.3 TXTIME and PSDU_LENGTH calculation. Expression (1) is equation 36-17 in 36.3.12.5 L-SIG of the same document. SignalExtension is described in Table 27-61-HE PHY characteristics in IEEE P802.11-REVme™/D5.0 “Draft Standard for Information technology—Telecommunications and information exchange between systems Local and metropolitan area networks—Specific requirements, Part 11: Wireless LAN Medium Access Control (MAC) and Physical Layer (PHY) Specifications,” February 2024.

In representative embodiments, the LLTI NDP 400 can be indicated explicitly by one or more fields in the U-SIG field 410. For example, the PHY Version Identifier field in the U-SIG field 410 of the LLTI NDP would be set to indicate that the PHY version thereof is UHR/UHR+. A PPDU Type field may be included in the U-SIG field 410 to indicate that the PPDU is a UHR/UHR+ LLTI NDP.

### Method II

In representative embodiments, the LLTI may be carried in a frame, referred to herein as an LLTI frame. The LLTI frame may be a control frame.

In representative embodiments, the LLTI frame may be carried in a legacy PPDU, such as for example, a non-HT PPDU, or a non-HT Dup PPDU. The SIG field in the PPDU may be set following certain rules so that concurrent transmissions of PPDUs carrying LLTI frames from multiple STAs, may be the same.

The Duration field of the LLTI frame may be set to a value which allows an unintended STA to set an NAV long enough to cover the maximum possible contention period right after the LLTI. In such an implementation, a Maximum Contention Period for LLTI may be predefined or determined and broadcasted by the AP. The Maximum Contention Period for LLTI may be the maximum backoff duration for STAs to access the wireless medium right after their LLTI transmission. The Duration field in the MAC header of the LLTI frame may be set to a value which is equal to or approximately equal to the Maximum Contention Period for LLTI. An unintended UHR/UHR+STA can use the Duration field of the LLTI frame to set its NAV. Whereas an unintended legacy STA may not understand it is an LLTI frame, it may be able to decode the frame's Duration field and use it to set its NAV.

The L-SIG field of the PPDU which carries the LLTI frame may be with a 6 Mb/s rate.

The TXVECTOR parameter SCRAMBLER_INITIAL_VALUE of the PPDU that carries the LLTI frame may be set to a fixed value so that all STAs may use the same scrambler seed to transmit the LLTI frame and thus the LLTI frame may remain the same and decodable if multiple STAs concurrently transmit the LLTI frame. In representative embodiments, said parameter may be set to the RXVECTOR parameter SCRAMBLER_INITIAL_VALUE of the last PPDU the STA received before the LLTI frame, or to a predefined value. In representative embodiments, the AP may choose a value for said parameter and broadcast it in a management frame, such as a Beacon frame, a Probe Response frame, an Association Response frame, or a control frame.

It is possible that a bandwidth signaling transmit address (TA) is not used in the LLTI frame. If the TA is not used, then the TXVECTOR parameter CH_BANDWIDTH_IN_NON_HT might not be present.

The Power Management and More Data subfields of the Frame Control field in the LLTI frame may be set to 0 (or another value). Other subfields of the Frame Control field of the LLTI frame should be set so that LLTI frames transmitted by different STAs are the same. In representative embodiments, all PPDU- and frame-related information is the same for all LLTI PPDUs and frames.

In representative embodiments, the LLTI may be carried in a field of a Media Access Control (MAC) header of a frame, such as, for example, the HT Control, A-Control, or QoS Control field, among others. In representative embodiments, the LLTI may be carried in a QoS Null frame in which the MAC header may be present with QoS Control field, and the MAC body absent. For example, Bit 7 of the QoS Null frame may be used for LLTI. In another example, Bit 7 of the QoS control field of the Null frame may be used to indicate that the QoS Null frame is carrying the LLTI.

### Method III

In representative embodiments, the LLTI may be solicited by an AP. The AP may allow the STAs to transmit the LLTI over the entire available bandwidth or over a bandwidth of multiples of 20 MHz so the transmission of the LLTI may be overlapped. In this way, the solicited LLTI may be carried by a PPDU of a preselected format, such as for example a non-HT PPDU, a non-HT Dup PPDU, or a UHR/UHR+PPDU, among others.

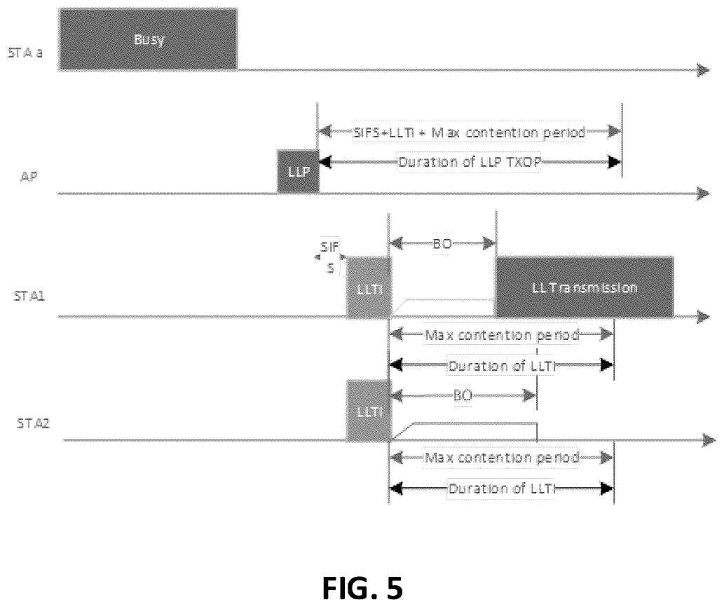

An exemplary procedure of AP solicitation of the LLTI is shown in FIG. 5. With such a procedure, an AP may transmit a frame to determine if any associated STAs or nearby STAs (including unassociated STAs) have low latency traffic. For example, the AP may transmit a special frame, referred to herein as a low latency polling (LLP) frame, to solicit LLTI transmission from STAs. The LLP frame may carry a field to indicate that it is an LLP frame. In representative embodiments, the LLP frame may be a Trigger frame. A new Trigger Type value may be defined and used to indicate that such a Trigger frame is an LLP Trigger frame. Alternatively, a special association ID (AID) value may be carried in the AID field in the User Info or Special User Info field to indicate that the frame is an LLP Trigger frame or that the Trigger frame carries low latency polling information. In the case that AID12 in the User Info field in a Trigger frame is used to indicate the LLP, the Trigger frame may allocate UL resources for LLTI and other types of trigger-based transmissions. As it is possible that the AP will not know which STA will transmit an LLTI in response to an LLP trigger frame, the Receiver Address (RA) field of the LLP frame may be set to a broadcast address. The Duration field of the LLP frame may be set to cover the possible contention period after the LLTI transmission. The Duration field may be set to cover the time duration of the Max Contention period for LLTI, and also account for the time between the reception of the LLP frame by a STA and the transmission by the STA of the LLTI, and for the time it takes the STA to transmit the LLTI. This duration is illustrated in FIG. 5. The LLP frame may allocate UL resources for the LLTI transmission. For example, it may indicate one or more 20 MHz subchannels allocated for LLTI transmission. The allocated subchannels may include the primary 20 MHz subchannel.

A STA that has low latency traffic may respond to an LLP frame with a Trigger-Based (TB) PPDU, non-HT PPDU, or non-HT Duplicate PPDU carrying the LLTI. Such an LLTI PPDU can be sent at an inter-frame spacing xFS after the reception of the LLP frame. “xFS” refers to some inter-frame spacing, such as a short inter-frame space (SIFS), for example, or a multiple thereof. xFS could be determined by the AP and indicated in the LLP, or it may be fixed for example, with a predefined value as may be specified by standard.

In the TB, non-HT, or non-HT Duplicate PPDU that carries the LLTI, all the fields in the L-SIG and SIG(s) for UHR or UHR+ may be specified to be set to the same values so that overlapping LLTI PPDUs from multiple STAs may be decodable.

In representative embodiments, the LLTI PPDUs from multiple STAs may be the same (i.e., the PLCP headers and MAC frames are the same) so that overlapping LLTI PPDUs may be decodable. However, since the LLTIs from different STAs would be the same, thus lacking STA-specific information, the AP would not be able to distinguish which STA transmitted the LLTI.

It should be noted that the field/subfield setting rules of the SIG fields and/or MAC frame of the LLTI disclosed for Methods I and II, may apply to Method III as well as a Method IV, described below.

At xIFS time after the transmission of the LLTI, the STAs which transmitted the LLTI may start a backoff procedure. In representative embodiments, the xIFS may be zero or SIFS. The duration of the backoff procedure may be limited by the parameter Max Contention Period for LLTI. The parameter Max Contention Period for LLTI may be predefined in the standard or selected and signaled by the AP, such as in the Beacon frame, for example.

In representative embodiments, the AP may configure the LLP frame to indicate that it is polling for low latency traffic that is above a certain priority threshold. In at least some such embodiments, the LLP frame may be in Basic Trigger frame format and the priority threshold may be indicated in the Trigger Dependent User Info subfield, e.g., the Preferred AC field. In representative embodiments in which the LLP frame is a newly defined LLP Trigger frame, as discussed above, a traffic priority field with the priority threshold may be carried in the Common Info field, the User Info field, the Special User Info field, and/or some other trigger-dependent info fields. For conditions in which the priority threshold may dynamically change from time to time, it may be desirable for it to be indicated in the LLP frame. If the priority threshold is to be static or substantially static, it may be indicated, for example, in a management frame. An STA that transmits an LLTI in response to the LLP frame may indicate its priority in the LLTI.

### Method IV

In representative embodiments, the LLTI may be solicited by an AP, which may allocate a set of Resource Units (RUs) for any STAs that respond to the solicitation to perform uplink OFDMA random access (UORA) transmission to carry the LLTI. In this way, the solicited LLTI may be carried by a UHR/UHR+TB PPDU. An LLTI transmitted using UORA may also be referred to herein as a UORA LLTI.

In such implementations, similarly to Method Ill, an AP may transmit an LLP frame to determine if any associated STAs or nearby STAs have low latency traffic. The LLP frame may carry a field to indicate that it is an LLP frame. In representative embodiments, the LLP frame may be a Trigger frame. A new Trigger Type value may be defined and used to indicate that such a Trigger frame is an LLP Trigger frame. Alternatively, a special association ID (AID) value may be carried in the AID field in the User Info or Special User Info field to indicate that the frame is an LLP Trigger frame or that the Trigger frame carries low latency polling information. The Trigger Type value and/or the special AID value may further indicate that the LLP frame solicits LLTIs that use UORA transmission. The Receiver Address (RA) field of the LLP frame may be set to a broadcast address, since it is possible that the AP will not know which STA will transmit an LLTI in response to an LLP trigger frame.

As with Method III described above, in representative embodiments, the AP may configure the LLP frame to indicate that it is polling for low latency traffic that is above a certain priority threshold. In at least some such embodiments, the LLP frame may be in Basic Trigger frame format and the priority threshold may be indicated in the Trigger Dependent User Info subfield, e.g., the Preferred AC field. In representative embodiments in which the LLP frame is a newly defined LLP Trigger frame, as discussed above, a traffic priority field with the priority threshold may be carried in the Common Info field, the User Info field, the Special User Info field, and/or some other trigger-dependent info fields. For conditions in which the priority threshold may dynamically change from time to time, it may be desirable for it to be indicated in the LLP frame. If the priority threshold is to be static or substantially static, it may be indicated, for example, in a management frame. An STA that transmits an LLTI in response to the LLP frame may indicate its priority in the LLTI.

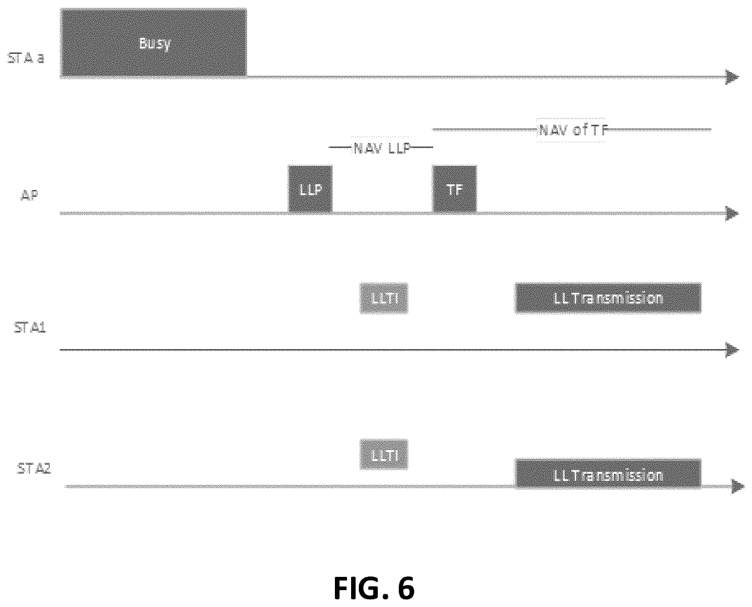

FIG. 6 illustrates an exemplary procedure of an AP soliciting UORA LLTIs and the subsequent transmission of low latency traffic from one or more STAs. In the procedure of FIG. 6, the AP transmits an LLP frame configured to solicit UORA LLTIs and having a Duration field set to cover the duration of the LLTI frame plus an xFS inter-frame space. xFS may be, for example, a SIFS, two times SIFS, or another multiple of SIFS. Upon receiving the LLP frame, a STA with low latency traffic that satisfies certain priority condition(s), as may be specified in the LLP frame or by the general LLTI protocol, may randomly select one User Info field in the LLP frame and use the random-access resource unit (RA-RU) or RA-RUs specified in that User Info field to transmit its LLTI. In representative embodiments, such an LLTI frame may have the UHR/UHR+ LLTI NDP format illustrated in FIG. 4, carrying the fields shown therein. In addition, the LLTI frame may carry some user-specific field(s) such as UHR/UHR+ SIG field(s). The LLTI frame may contain STA-specific information, including, for example, one or more of the STA's ID and/or address, its low latency traffic QoS information, its requested low latency traffic transmission duration, etc. Note that the field/subfield setting rules for the SIG fields, and MAC frame of the LLTI disclosed for Methods I to III may apply here as well. The PPDU and/or MAC frame which carries the LLTI may also carry fields such as, for example, one or more of Suggested MCS, LL traffic size/length, LL Delay Bound, TID/AC of the LL traffic, etc. The Suggested MCS may indicate suggested MCS for the STA (e.g., non-AP STA) so that the AP may assign the MCS for the STA in the following Trigger frame. The LL traffic size/length may indicate the low latency traffic size/length of the STA (e.g., non-AP STA) so that the AP may estimate the maximum UL data length to be used in the TB PPDU among all the users and assign the UL Length field properly in the following Trigger frame. The LL Delay Bound may indicate how urgently the STA needs to transmit the low latency traffic. This information may help the AP to schedule UL transmissions in a suitable order. The Traffic Identifiers (TIDs) and/or Access Categories (AC) of the low latency traffic may indicate the TIDs and/or ACs of the low latency traffic of a STA (e.g., a non-AP STA) so that the AP may associate the TIDs/ACs with the low latency traffic and may use this information, for example, to ensure compliance with applicable LLTI transmission rules.

If a given RA-RU is used by only one STA to transmit its LLTI, the AP will be able to decode the LLTI. Otherwise, if there are multiple STAs transmitting their LLTIs on the same RA-RU or RA-RUs, the AP cannot decode the colliding LLTIs. The AP then sends a trigger frame (TF) to further facilitate the low latency data transmission for those surviving STAs that grabbed RA-RU(s) without collision. In the example scenario depicted in FIG. 6, STA1 and STA2 have transmitted respective LLTIs on different RA-RUs, without collision, and thus represent the aforementioned surviving STAs.

In the TF, the AP may set the duration for the subsequent low latency transmission. In setting this duration, the AP may consider the requested low latency traffic transmission duration information received in the decoded LLTIs. In each of one or more User Info fields in the TF, the AP may respectively specify the AID of each of one or more surviving STAs, its resources unit allocation, and other information for its low latency data transmission. After receiving the TF, all STAs that are coordinated by the TF will send their low latency traffic as specified by the TF. In the example scenario of FIG. 6, STA1 and STA2 send their low latency traffic as specified by the TF.

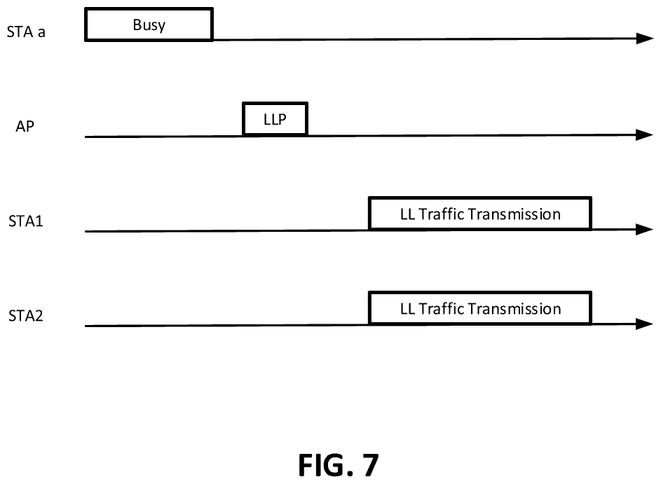

In another exemplary method as shown in FIG. 7, instead of soliciting LLTIs, the AP solicits low latency traffic from the STAs. As depicted in FIG. 7, the AP may send an LLP frame to indicate that it reserves a NAV duration after the LLP frame for low latency traffic above a certain priority threshold. The LLP frame may allocate a set of RA-RUs for the STAs to perform uplink OFDMA random access (UORA) transmission of their low latency traffic. Each of the STAs then randomly grabs one such RA-RU allocation and sends its low latency traffic. Note that the STAs may do so without first having transmitted LLTIs. If only one STA is transmitting on a certain RA-RU allocation, its transmission may be successfully decoded at the AP; otherwise, if multiple STAs transmit on the same RA-RU allocation, their PPDUs would collide and may not be decodable at the AP. If this occurs, the AP can repeat a procedure in accordance with this method or any of the other methods described herein.

It should be noted that while a Trigger frame is used to carry the LLP in the procedures and examples described, the LLP may be carried by other frames. For example, the LLP may be carried by the Triggered Response Scheduling (TRS) field in the HT Control field. The Reserved bit in the TRS field may indicate that the TRS field is carrying an LLP. This can be done with embodiments in accordance with Methods III and IV.

Additionally, in representative embodiments in accordance with Methods III and IV, the AP may configure the LLP to solicit LLTIs and/or traffic from one or more specific STAs by indicating in the LLP the IDs and/or addresses of the intended STAs. In representative embodiments, the AP may configure the LLP to indicate that it is polling for periodic low latency traffic.

While this disclosure refers to “low latency traffic,” the methods and apparatuses disclosed herein are not limited to low latency traffic but may also be implemented for other types of high priority traffic, traffic for which it may be necessary or desirable to provide high priority transmission, or transmission of a higher priority than non-high priority traffic. As such for example, an indication such as the LLTI described above that can be used for high priority traffic may be referred to as a high priority traffic indication (HPTI) or an indication of high priority traffic, containing some or all of the same information or equivalents thereof as the LLTI.

Various numeric values are used in the present disclosure. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. So, in this example, a first operation need not be performed before a second operation, and may occur, for example, before, during, or in an overlapping time period with the second operation.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information may include one or more of, for example, estimating the information, calculating the information, predicting the information, or retrieving the information from memory.

Further, this disclosure may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter-frame spacing in the examples of the designs and procedures, all other inter-frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a station (STA), the method comprising:
transmitting a frame with an indication of high priority traffic and associated transmission parameters over a wireless medium in a Wireless Local Area Network (WLAN);
performing backoff before transmitting the high priority traffic;
determining whether a transmission over the wireless medium has occurred during the backoff;
transmitting the high priority traffic over the wireless medium if it is determined that a transmission over the wireless medium during the backoff has not occurred; and
deferring transmitting the high priority traffic over the wireless medium if it is determined that a transmission over the wireless medium has occurred during the backoff.

2. The method of claim 1, wherein the indication is included in a PPDU.

3. The method of claim 2, wherein the PPDU is at least one of a UHR, UHR+, non-HT, non-HT Duplicate, or NDP PPDU.

4. A method for a station (STA), the method comprising:
receiving a high priority traffic solicitation from an Access Point (AP) over a wireless medium in a Wireless Local Area Network (WLAN); and
transmitting at least one of an indication of high priority traffic or high priority traffic over the wireless medium in accordance with the high priority traffic solicitation.

5. The method of claim 4, wherein the indication is included in a TB, non-HT, non-HT Duplicate, UHR, or UHR+PPDU.

6. The method of claim 4, wherein the solicitation is included in a trigger frame.

7. The method of claim 4, wherein the indication is transmitted using an entire bandwidth or a portion of the bandwidth of the wireless medium, the portion of the bandwidth being multiples of 20 MHz.

8. The method of claim 4, wherein the high priority traffic is transmitted using one or more Random Access Resource Units.

9. The method of claim 1, wherein the high priority traffic includes low latency traffic.

10. A station (STA) comprising:
a transceiver and a processor communicatively coupled to the transceiver, the transceiver and processor configured to:
transmit a frame with an indication of high priority traffic and associated transmission parameters over a wireless medium in a Wireless Local Area Network (WLAN);
perform backoff before transmitting the high priority traffic;
determine whether a transmission over the wireless medium has occurred during the backoff;
transmit the high priority traffic over the wireless medium if it is determined that a transmission over the wireless medium during the backoff has not occurred; and
defer transmitting the high priority traffic over the wireless medium if it is determined that a transmission over the wireless medium has occurred during the backoff.

11. The STA of claim 10, wherein the indication is included in a PPDU.

12. The STA of claim 11, wherein the PPDU is at least one of a UHR, UHR+, non-HT, non-HT Duplicate, or NDP PPDU.

13. A station (STA) comprising:
a transceiver and a processor communicatively coupled to the transceiver, the transceiver and processor configured to:
receive a high priority traffic solicitation from an Access Point (AP) over a wireless medium in a Wireless Local Area Network (WLAN); and
transmit at least one of an indication of high priority traffic or high priority traffic over the wireless medium in accordance with the high priority traffic solicitation.

14. The STA of claim 13, wherein the indication is included in a TB, non-HT, non-HT Duplicate, UHR, or UHR+PPDU.

15. The STA of claim 13, wherein the solicitation is included in a trigger frame.

16. The STA of claim 13, wherein the indication is transmitted using an entire bandwidth or a portion of the bandwidth of the wireless medium, the portion of the bandwidth being multiples of 20 MHz.

17. The STA of claim 13, wherein the high priority traffic is transmitted using one or more Random Access Resource Units.

18. A method for an access point (AP), the method comprising:
transmitting to a station (STA) over a wireless medium in a Wireless Local Area Network (WLAN) a high priority traffic solicitation; and
receiving from the STA at least one of an indication of high priority traffic or high priority traffic over the wireless medium in accordance with the high priority traffic solicitation.

19. The method of claim 18, wherein the indication is included in a TB, non-HT, non-HT Duplicate, UHR, or UHR+PPDU.

20. The method of claim 18, wherein the solicitation is included in a trigger frame.

21. The method of claim 18, wherein the indication is transmitted using an entire bandwidth or a portion of the bandwidth of the wireless medium, the portion of the bandwidth being multiples of 20 MHz.

22. The method of claim 18, wherein the high priority traffic is transmitted using one or more Random Access Resource Units.

23. The method of claim 18, wherein the high priority traffic includes low latency traffic.
